(19) United States
(12) Patent Application Publication
(10) Pub. No.: US 2012/0025758 A1
(43) Pub. Date: Feb. 2, 2012

(54) CONTACTLESS POWER TRANSFER SYSTEM

(75) Inventors: Adnan Kutubuddin Bohori, Bangalore (IN); James William Bray, Niskayuna, NY (US); Kumar Vaibhav Srivastava, Kanpur (IN); Somakumar Ramachandrapanicker, Bangalore (IN); Jay Chakraborty, Jamshedpur (IN); Suma Memana Narayana Bhat, Bangalore (IN); Neelmegh. R, Bangalore (IN)

(73) Assignee: GENERAL ELECTRIC COMPANY, SCHENECTADY, NY (US)

(21) Appl. No.: 12/845,133

(22) Filed: Jul. 28, 2010

(51) Int. Cl. H02J 7/00

(52) U.S. Cl. 320/108

(57) ABSTRACT

A contactless charging system is presented. The contactless charging system includes an electrical outlet coupled to a power source and comprising a primary coil. An inlet on a vehicle comprising a dielectric region is disposed within a cavity. A secondary coil is disposed within the cavity and coupled to a storage module. A field focusing element is disposed proximate the dielectric region and configured to focus a magnetic field.

### BACKGROUND

The invention relates generally to contactless power transfer systems and, in particular, to contactless power transfer for plug-in hybrid vehicles and electric vehicles.

A typical motor vehicle with an internal combustion engine has a battery that is used predominantly for providing power to crank the engine to start the vehicle. Charging the battery is usually done via an alternator driven by the engine. However, in a plug-in hybrid or all electric vehicle, the battery typically provides power to an electric motor coupled to a drive shaft to drive the vehicle. The power storage capacity of an electric vehicle battery typically has to be sufficient to deliver power in a range similar to that of a vehicle powered by a combustion engine. Such power requirements involve recharging over extended periods of time such as, for example, overnight or during the work day while the vehicle is parked.

To date, most electric vehicle charging systems includes contact based charging connectors having plug and socket connectors for contact based charging. Contact based charging connector systems have several disadvantages. For example, in outdoor applications, environmental impact may cause corrosion and damage of electrical contacts. The power cord and plug connectors may become damaged due to improper or excessive use by different people at the charging station.

It would therefore be advantageous to provide contactless vehicle charging.

### BRIEF DESCRIPTION

It would further be advantageous to provide a contactless vehicle charging system that can allow the electrical contacts to be permanently concealed inside insulating casing. Further, it would be useful for the system to be capable of ensuring a correct charging rate and total charge delivered to the vehicle to prevent overcharging. Additionally, it would be useful for the system to provide smart grid compatibility to enable intelligent charging and effective utilization of electrical power from the utility.

Briefly, in accordance with one embodiment, a contactless charging system is presented. The contactless charging system includes an electrical outlet coupled to a power source and comprising a primary coil. An inlet on a vehicle comprising a dielectric region is disposed within a cavity. A secondary coil is disposed within the cavity and coupled to a storage module. A field focusing element is disposed proximate the dielectric region and configured to focus a magnetic field.

In another embodiment, an intelligent charging system is presented. The intelligent charging system includes a contactless power transfer system comprising at least two coils and a field focusing element. The intelligent charging system is configured for providing bi-directional power transfer between a power source and a storage module on a vehicle. A battery management system is coupled to the storage module and configured to control a power flow to and from the storage module. A processor is coupled to the power source and configured to communicate with an external control station.

In another embodiment, a vehicle having a charging receptacle is presented. The charging receptacle includes an inlet comprising a dielectric region disposed within a cavity. A secondary coil is disposed within the cavity and coupled to a storage module. A field focusing element is disposed proximate the dielectric region and configured to focus a magnetic field. The charging receptacle is configured for receiving a charging handle comprising a primary coil coupled to a power source.

### DRAWINGS

These and other features, aspects, and advantages of the present invention will become better understood when the following detailed description is read with reference to the accompanying drawings in which like characters represent like parts throughout the drawings, wherein:

FIG. 1 illustrates an exploded view of a contactless charging system according to an embodiment of the invention;

FIG. 2 illustrates a charging receptacle according to an embodiment of the invention;

FIG. 3 illustrates a charging handle according to an embodiment of the invention;

FIG. 4 illustrates a contactless charging system according to an embodiment of the invention;

FIG. 5 illustrates a block diagram of a contactless charging system according to an embodiment of the invention;

FIG. 6 illustrates a block diagram of an intelligent charging system according to an embodiment of the invention;

FIG. 7 illustrates an alternate embodiment of a contactless charging system according to an embodiment of the invention;

FIG. 8 illustrates a Swiss-roll resonator according to an embodiment of the invention; and

FIG. 9 illustrates charging receptacle according to an embodiment of the invention.

### DETAILED DESCRIPTION

As used herein, “contactless” means that a power cord, wire, or other tangible electrical conduit is absent for at least a portion of a power transfer circuit. Unless otherwise indicated by context or explicit language, “power,” as used herein, refers to electrical power or electricity. The word “vehicle” is intended to include any non-fixed item of equipment, and specifically includes at least self-propelled vehicles. Examples of such vehicles include passenger vehicles, mass transit vehicles, locomotives, and industrial equipment (such as forklifts and loaders). Examples of passenger vehicles include all-electric vehicles and plug-in hybrid electric vehicles. Other examples include mining equipment and semi-portable devices. The terms “primary coil” and “secondary coil” are provided with reference to the directional flow of power. In certain instances, power flow may be bi-directional, and the terms may be interchanged with each other. The phrases “connected to,” “coupled to,” and “in communication with” refer to any form of interaction between two or more entities, including mechanical, electrical, magnetic, electromagnetic, fluid, and thermal interaction. Two components may be coupled to each other even though they are not in direct contact with each other.

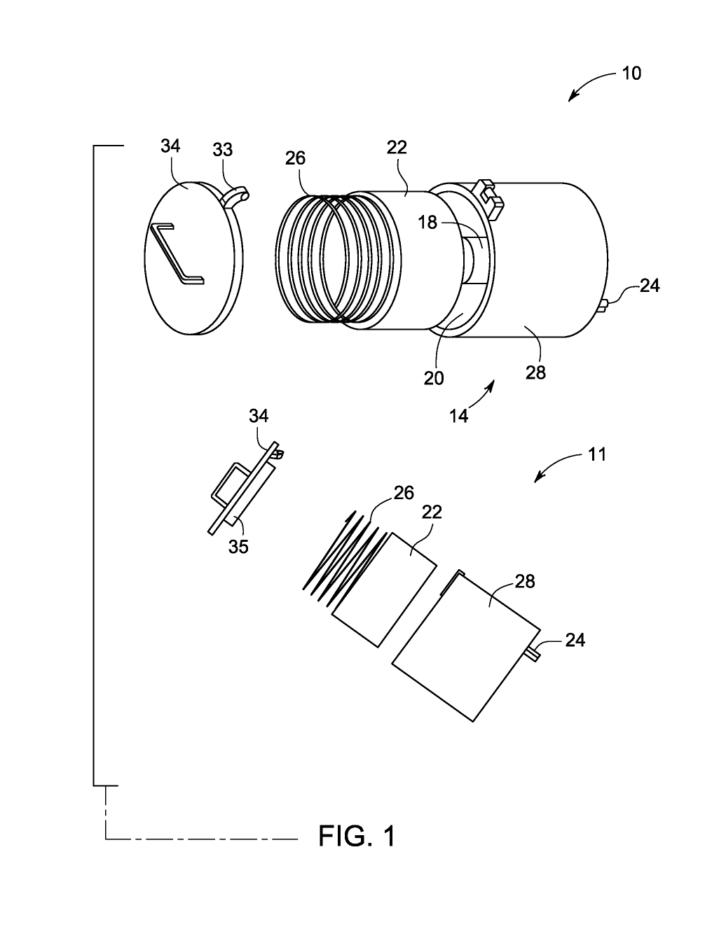

FIG. 1 illustrates an exploded view of a contactless charging system according to an embodiment of the invention. A charging receptacle 14 is disposed on a vehicle (not shown) and illustrated as an inlet for purposes of example. In one embodiment, the charging receptacle 14 includes a cavity 20 for hosting a dielectric region 22, a projection 18 for hosting a secondary coil 24, and a field-focusing element 26. In one embodiment, the charging receptacle 14 comprises a housing 28 made of ferromagnetic material for example. In another embodiment, the charging receptacle housing 28 and projection 18 both comprise ferromagnetic material. Ferromagnetic material helps to minimize penetration of magnetic fields generated by the primary coil and field-focusing element into surrounding metal frames and additionally helps to minimize the electromagnetic interference with adjacent electronic systems. In one embodiment, as shown in FIG. 1, the dielectric region 22 encompasses the field-focusing element 26. Non-limiting examples of dielectric region materials include calcium copper titanate compositions and barium strontium titanate compositions. Using a dielectric enclosure around the field-focusing element 26 improves the permittivity and thus results in enhanced field focusing from the field-focusing element 26. The charging receptacle 14 may further include a lid 34 disposed on the outside on the vehicle and optionally coupled by a hinge 33 to the housing 28 of the cavity 20. Reference numeral 11 illustrates another view of the charging receptacle 14. In one embodiment, a projection 35 on the lid 34 is configured to accommodate a charging handle (not shown in FIG. 1) during a charging operation.

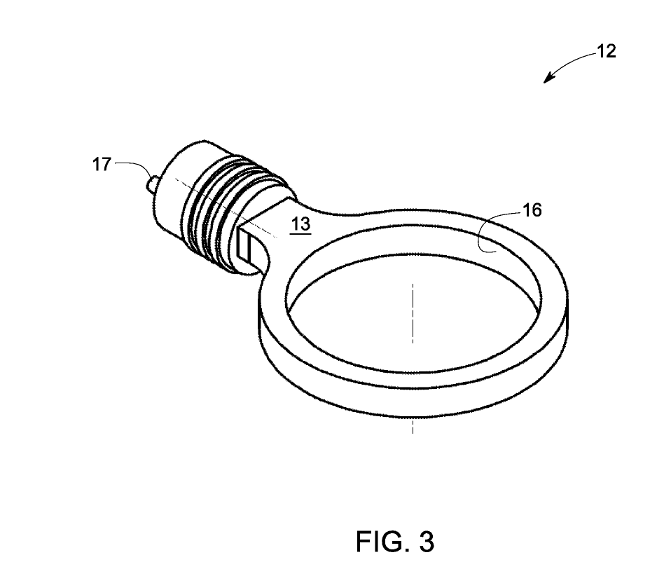

The field-focusing element 26 is used to focus a magnetic field from a primary coil 16 (as referenced in FIG. 3) on to the secondary coil 24. In one embodiment, the field-focusing element 26 includes a single loop coil. In another embodiment, the field-focusing element includes multiple turns such as in a split ring structure, a spiral structure, a Swiss-roll structure, or a helical coil. Selection of a structure for a particular application is determined by the power handling capability, self resonating frequency, and ability to focus the electromagnetic field in an axial direction to facilitate the contactless charging system. For example, passenger electric vehicles may have storage systems with energy ratings of about 8 kWh to about 40 kWh. Such storage systems are configured for at least three levels of charging depending on the time required for charging. For example, a level one charging requires charging power of about 1.5 kW to about 7 kW, a level two charging requires charging power of about 10 kW to 15 kW, and a level three charging requires charging power of about 15 kW up to about 150 kW (with a level three charging requiring less charging time than level one and two chargings). Similarly for high power vehicles such as mining trucks, power requirements may be in the range of 200 kW or more. Such high power requirements need operating frequency to be less than a few MHz up to about 500 kHz.

A Swiss-roll coil may be implemented as the field-focusing element to provide a compact resonator that may be configured to operate at frequencies from about 100 kHz up to about a few MHz. Swiss-roll resonators includes spiral wrapped coils that may be embedded in high dielectric material (with a dielectric constant ranging from 10 to 100, for example) to achieve increased capacitance and inductance and hence a compact design. A single Swiss Roll resonator is expected to be capable of focusing a magnetic field up to few inches of distance.

Alternatively, a helical resonator may be embedded in dielectric region 22 and configured as a field focusing structure. This embodiment of helical structure may include a wire wound in the form of a helix and, when used as magnetic field-focusing element, may achieve high Q factor. In one embodiment, coating the surface of the conductor in the helical structure with high conductivity material helps minimize skin effects in the magnetic field-focusing element at high frequencies and hence enables the higher Q factor. A helical resonator is analogous to an array of dipoles and loops and designed for focusing magnetic field in an axial direction by optimizing the pitch and number of turns.

The field-focusing element 26 may further include multiple resonators. In one embodiment, the field-focusing element 26 comprises at least two sets of resonators having self-resonant frequencies that are unique (in other words, that differ from each other). In such a configuration, power may be transferred through a first resonance frequency and data on a second resonance frequency. If desired, bi-directional power or power and data may be transferred. In one example, power is transferred in one direction via the first resonance frequency and data is transferred in an opposite direction via the second resonance frequency simultaneously.

The secondary coil 24 disposed within the cavity may be coupled to an energy storage module (not shown) within an electric vehicle or a plug-in hybrid vehicle that is powered by an electric motor. The energy storage module may in turn be configured to supply power to the electric motor.

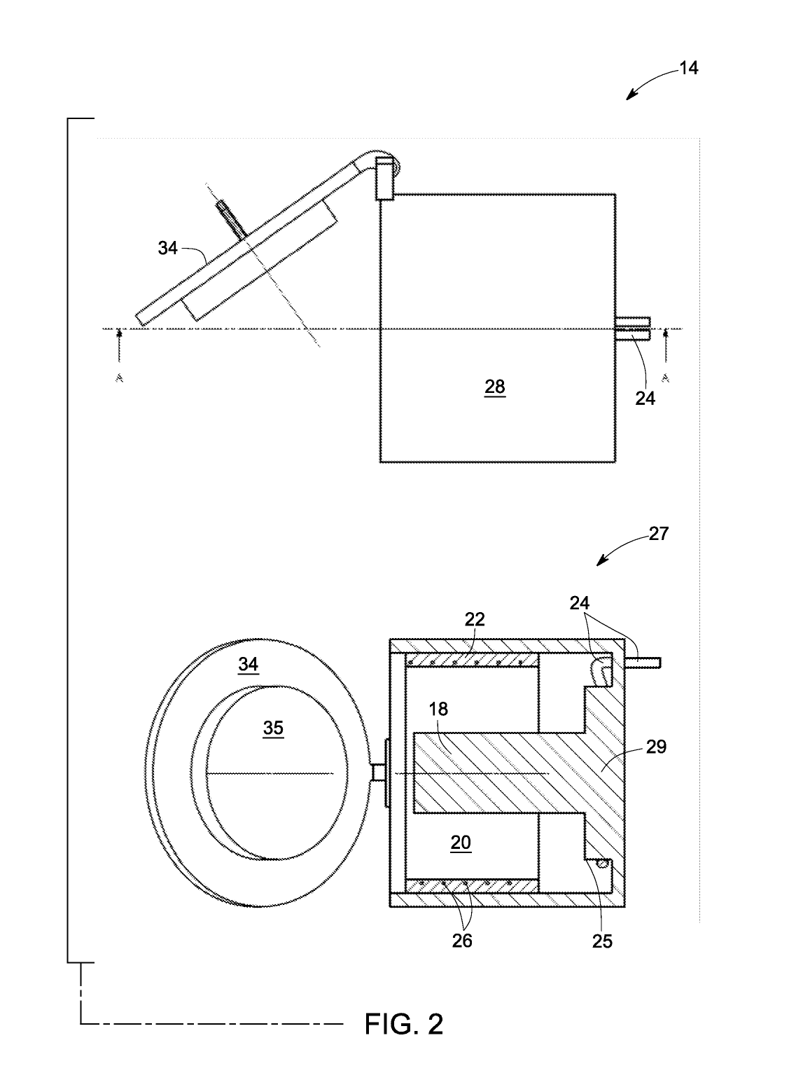

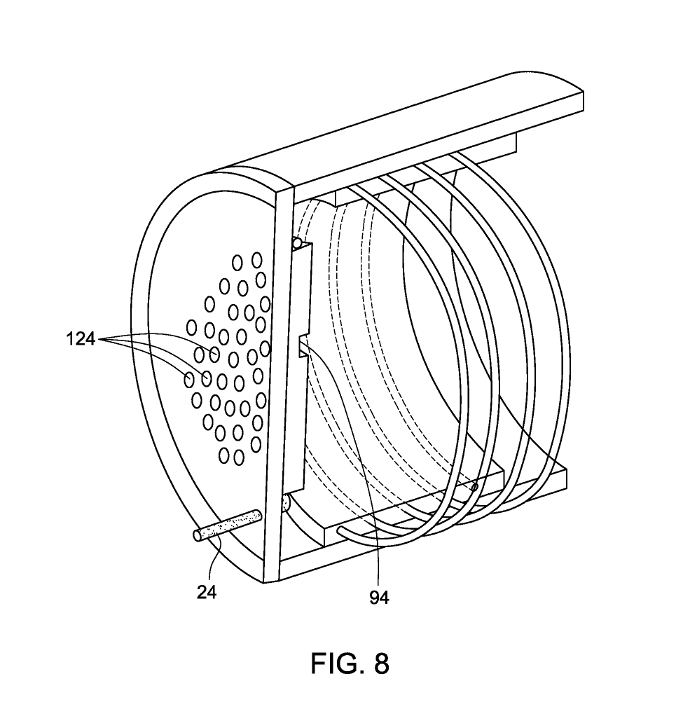

FIG. 2 illustrates the charging receptacle according to an embodiment of the invention. The top view 14 illustrates the lid 34 hinged to the outer surface 28 of the cavity. The leads of the secondary coil 24 may be coupled to the electric motor or the storage system within the vehicle. A cut sectional view as referenced by the numeral 27 illustrates the projection 18 hosting the secondary coil 24 at the far end 25 within the cavity 20. The cut sectional view 27 also illustrates the field-focusing element 26 disposed proximate the dielectric region 22. For example, the dielectric region 22 may encompass the helical resonator 26 as illustrated by the cut section view 27. In another embodiment, the dielectric region 106-110 may be disposed between or wrapped around the coil regions 98-104 of a Swiss-roll resonator as illustrated by reference numeral 97 in FIG. 8. As discussed earlier, the projection 35 on the lid 34 is to accommodate a charging handle. During a charging operation, the lid hosts the charging handle and is in a closed position wherein the projection 35 along with the charging handle is accommodated within the cavity 20. After the charging, the lid 34 is replaced into the cavity 20 without the charging handle.

FIG. 3 illustrates a charging handle 13 according to an embodiment of the invention. A primary coil 16 is disposed within a housing 12 and configured to be disposed on the projection 35 of the lid 34 as referenced in FIG. 2. The housing 12 may comprise a non-conducting and non-magnetic material such as plastic, for example. The primary coil 16 is further coupled to a charging station, which in turn is coupled to a power source (not shown) such as an AC power outlet of a domestic home or an industrial three-phase power outlet via the leads 17. The charging station converts frequency of the power received from the power source or utility from power frequency of 50/60 Hz to a resonance frequency of the field-focusing element to enable the efficient power transfer.

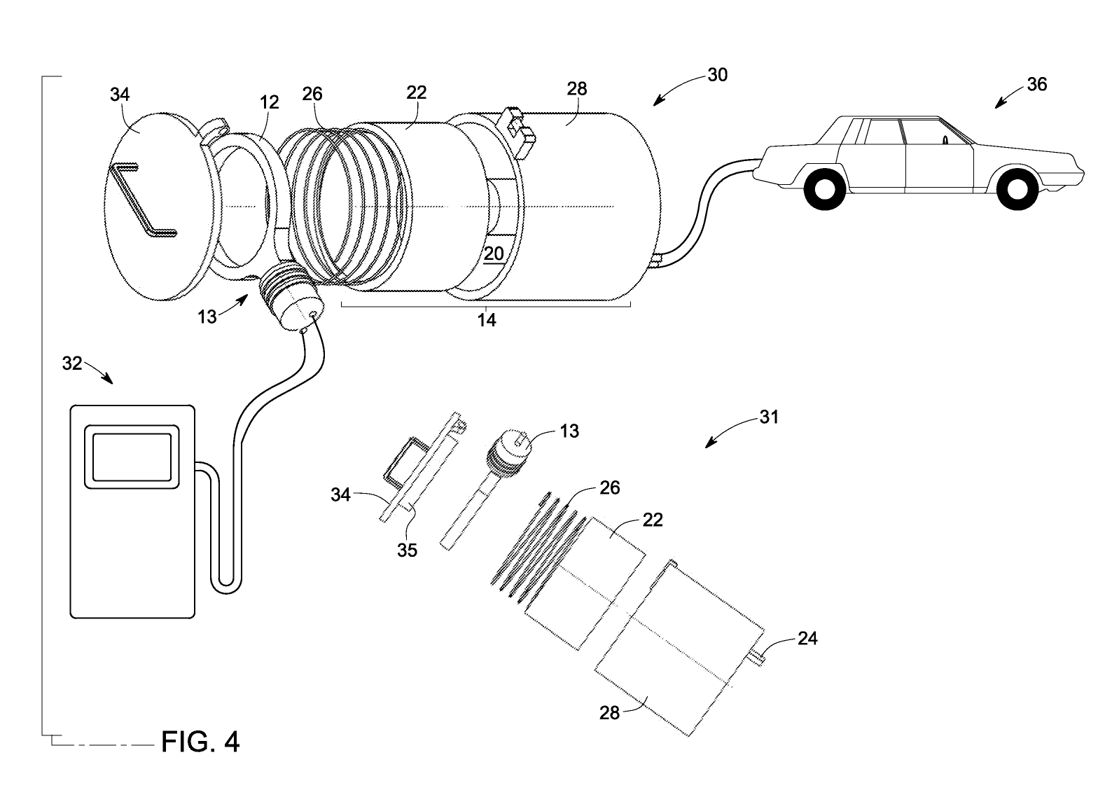

FIG. 4 illustrates a contactless charging system 30 according to an embodiment of the invention. In an exemplary embodiment, the charging handle housing 12 is mated into the projection 35 during a charging operation. The contactless charging system 30 includes a charging station 32 that may be coupled to a utility grid. The charging station 32 is adapted to supply power to a vehicle 36 that is capable of receiving power, for example, recharging the storage devices within the vehicle. Charging handle 13 is electrically coupled to the charging station 32. A charging receptacle 14 disposed on the vehicle 36 includes a cavity 20 having field-focusing element 26 and secondary coil 24 disposed within the cavity 20. As discussed above, secondary coil 24 may be coupled to an energy storage module within the vehicle that is powered by an electric motor. The energy storage module is configured to supply power to the electric motor to propel the vehicle. Reference numeral 31 illustrates another view of the contactless charging system 30.

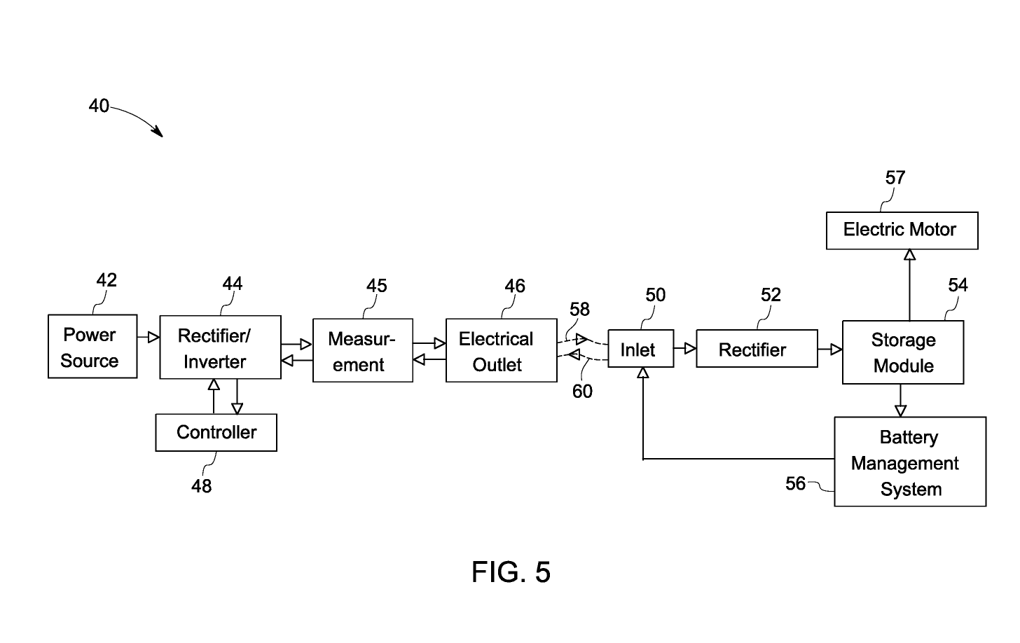

FIG. 5 illustrates a block diagram of a contactless charging system according to an embodiment of the invention. The contactless charging system 40 includes a power source 42 that is coupled to a grid. The power source 42 is configured to supply single phase or three phase AC power. A rectifier/inverter module 44 coupled to the power source 42 comprises a rectifier which converts the AC power to DC power and an inverter which then converts the rectified DC power to high frequency AC power. A controller 48 coupled to the rectifier/inverter module 44 controls the on and off states of switches of the rectifier/inverter module. An electrical outlet 46 is coupled to the rectifier/inverter module 44.

The electrical outlet 46, in one embodiment, includes a charging handle equipped with a primary coil for transmitting high frequency AC power from the rectifier/inverter module 44. An inlet 50 is disposed on a vehicle configured to receive power for charging purposes. The electrical outlet 46 and the inlet 50 are mechanically mated so that during charging operation, the inlet 50 accommodates electrical outlet 46 for receiving power. In one embodiment, the inlet 50 includes a field-focusing element enclosed within a dielectric region to focus a magnetic field and a secondary coil to receive power. In may be noted that, though electrical outlet 46 and inlet 50 are mechanically mated, the primary and secondary coils are not in physical contact. Power 58 is transferred in a contactless manner between the electrical outlet 46 and the inlet 50. The secondary coil may further be coupled to a rectifier 52 to convert high frequency AC power to a DC power suitable for charging a storage module 54. In one embodiment, the storage module 54 includes a battery or multiple batteries. The storage module 54 may be further coupled to an electric motor 57 configured to propel a vehicle (not shown in FIG. 4). A battery management system 56 is coupled to the storage module 54 and configured to monitor the amount of charging required for the storage module 54. Furthermore, battery management system 56 may be configured to provide signals for use in controlling on and off states of switches of the rectifier/inverter module 44 such that the power flow into the storage module 54 is controlled. Such a feedback mechanism, in an exemplary embodiment, is implemented via data transfer 60 in a contactless manner between the inlet 50 and the electrical outlet 46. For example, during a charging operation, the battery management system 56 may generate a signal when the storage module 54 is fully charged and does not require any more charging. Such signal may be transmitted to the controller 48 in a contactless manner via the inlet 50 and electrical outlet 46. Similarly, battery management system 56 may communicate via appropriate signals, the status of the storage module 54 at any stage during the charging operation.

In one embodiment, a power-flow measuring module 45 is coupled between the rectifier/inverter 44 and the primary coil in the electrical outlet 46. Power-flow measuring module 45 may be configured to measure the amount of power delivered from the electrical outlet. Such measurements may be used for utility billing purposes. Furthermore, such measurements help monitor abnormal operations that may occur, for example, during an incompatible charging handle being used for a vehicle or during a fault condition that may occur during a short circuit. During such abnormal conditions, an alarm device within the power-flow measuring module may be activated to warn the user to abort the operation.

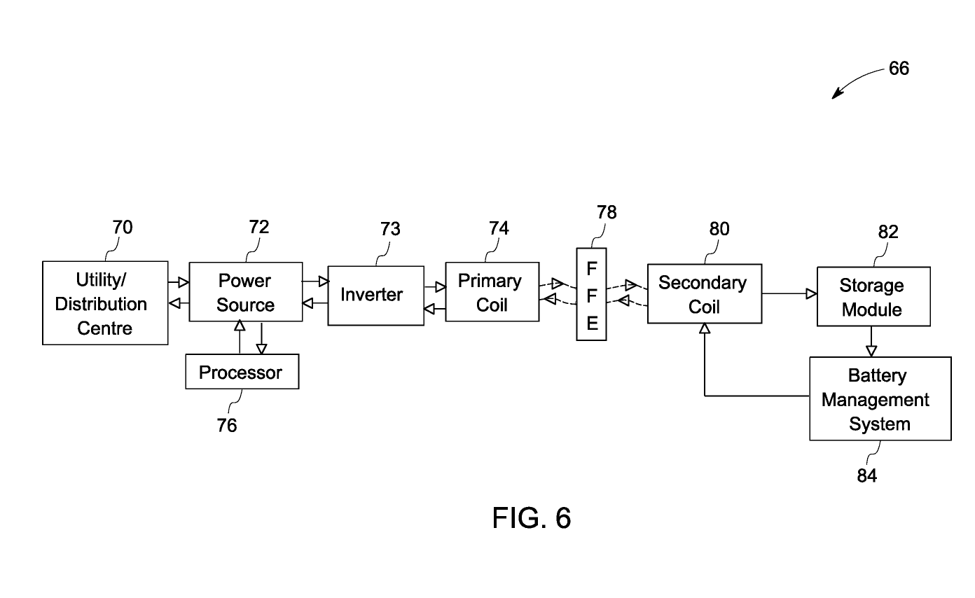

FIG. 6 illustrates a block diagram of an intelligent charging system according to an embodiment of the invention. The intelligent charging system 66 includes at least two sets of coils 74, 80, a field-focusing element 78 and is configured for providing multi-channel bi-directional power transfer between a power source 72 and a storage module 82 on a vehicle (not shown in FIG. 5). An inverter 73 coupled to the power source may be configured to convert power to high frequency AC power suitable for contactless power transmission. A battery management system 84 is coupled to the storage module 82 and configured to control a power flow to and from the storage module 82. A processor 76 is coupled to the power source and configured to communicate with an external control station 70. The external control station 70 may include, for example, a utility based power distribution unit or a distributed power generation unit. Several examples of distributed power generation units include photovoltaic modules, wind farms, and micro generation units. Several examples of utility distribution unit include substations and receiving stations coupled to a transmission grid.

In an exemplary embodiment, while the primary and secondary coils are coupled, the intelligent charging system 66 may be configured to include smart grid capabilities such as optimum load utilization and enable functionality such as the transfer of power from the storage module to the grid when it appears that such power will be needed by the grid prior to being needed by the vehicle. In one embodiment, load data such as the charging current and the power flow into the power source 72 may be monitored and communicated to the utility 70 via the processor 76. It may be noted that sharing such data with the utility is advantageous in several aspects. For example, when multiple such vehicles are coupled to the grid at the same time during the night, multiple such intelligent systems as disclosed herein may be coupled configured to share the demand for load thereby relieving an overload condition on the grid. Additionally, if a vehicle is fully charged, excess power from such a vehicle may be pumped back to the grid to relieve new demand for power on the grid. Many such load optimization techniques may be implemented within the intelligent charging system 66. Further details of contactless power transfer systems in general and data transfer in particular can be found in co-pending U.S. patent application Ser. No. 12/820,208, filed on Jun. 22, 2010, entitled “CONTACTLESS POWER TRANSFER SYSTEM.”

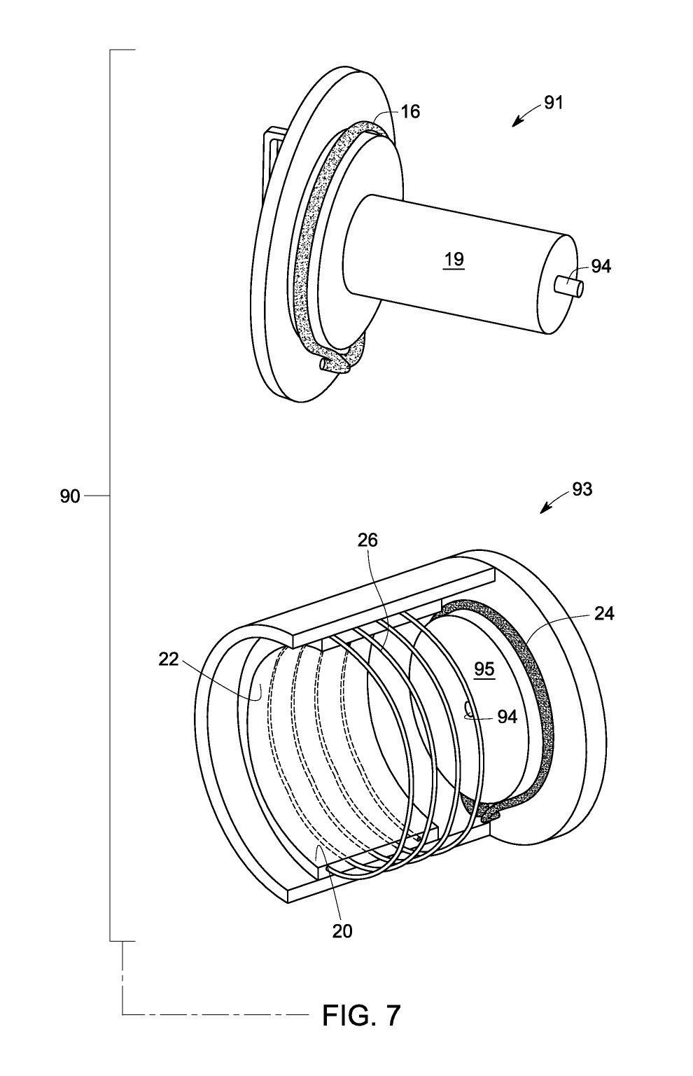

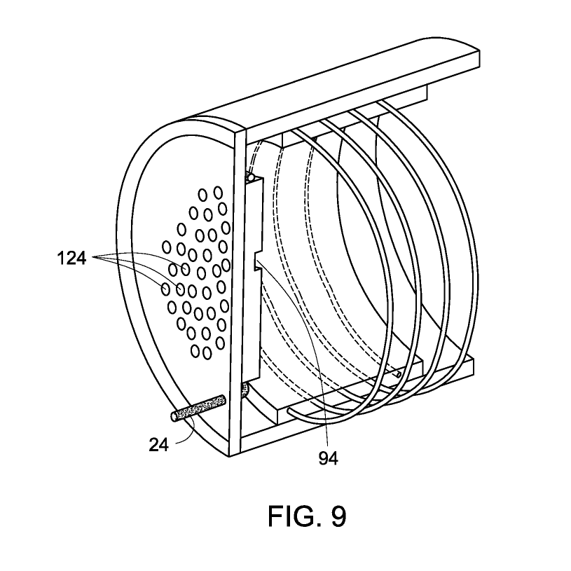

FIG. 7 illustrates an alternate embodiment of a contactless charging system according to an embodiment of the invention. The contactless charging system 90 includes a charging receptacle 93 that includes a cavity 20 to accommodate the dielectric region 22 and a field-focusing element 26. A projection 95 within the cavity 20 is configured to host a secondary coil 24. A charging handle 91 includes a projection 19 that is hosted within the cavity 20 during a charging operation. Alignment key 94 on the projection 19 may be used to align a fit into the hole 94 on the projection 95 within the charging receptacle 93 during a charging operation. The charging handle 91 further hosts a primary coil 16 coupled to the utility grid via a charging station. In an alternate embodiment, the charging receptacle 93 is further configured to receive liquid fuel via multiple perforations such as 124 as referenced in FIG. 9. It may be noted that such an arrangement is advantageous in plug-in hybrid electrical vehicles that can operate using fuel or electricity. In one embodiment, a housing for cavity 20, projection 95, and projection 19 each comprise ferromagnetic material.

Advantageously, contactless charging systems as disclosed herein are more efficient compared to induction based charging systems. Further, high efficiencies may be achieved (such as about 90% or more for a 6.6 kW system) over a distance of few millimeters. The contactless charging system is further insensitive to any misalignment between the charging handle and the charging receptacle. Furthermore, such contactless charging systems are immune to load variations that occur at various stages of battery charging/discharging. Bi-directional power transfer enables simultaneous transfer of power and data. Power-flow monitor and alarm functions may be used to enable overall system protection during abnormal operations such as in-compatible devices or faulty device. Intelligent charging systems disclosed herein may be used to enable smart grid capabilities such as load optimization and resource sharing.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A contactless charging system comprising:
an electrical outlet coupled to a power source and comprising a primary coil;
an inlet on a vehicle comprising a dielectric region disposed within a cavity;
a secondary coil disposed within the cavity and coupled to a storage module; and
a field focusing element disposed proximate the dielectric region and configured to focus a magnetic field.

2. The contactless charging system of claim 1, wherein the primary coil is disposed within a housing comprising at least one of a non-magnetic and non-conducting material.

3. The contactless charging system of claim 1, wherein the electrical outlet comprises a projection and the primary coil is disposed around the projection.

4. The contactless charging system of claim 3, wherein the electrical outlet, the housing of the cavity, and the projection comprise a ferromagnetic material.

5. The contactless charging system of claim 1 further comprising a high frequency converter coupled between the primary coil and the power source to convert power frequency of the power source to high frequency.

6. The contactless charging system of claim 1 further configured for bi-directional power or power and data flow between the storage module and the power source.

7. The contactless charging system of claim 1, wherein the storage module is coupled to an electric motor.

8. The contactless charging system of claim 7, wherein the electric motor is coupled to a drive shaft of the vehicle.

9. The contactless charging system of claim 1, wherein the inlet is further configured to receive liquid fuel.

10. The contactless charging system of claim 1 further comprising a power-flow measuring module coupled to the primary coil.

11. The contactless charging system of claim 10, wherein the power-flow measuring module further comprises an alarm device.

12. The contactless charging system of claim 1, wherein the storage module comprises at least one battery.

13. The contactless charging system of claim 12, wherein the at least one battery is coupled to a battery management system.

14. The contactless charging system of claim 13, wherein the battery management system is configured to control power flow from the electrical outlet.

15. An intelligent charging system comprising:
a contactless power transfer system comprising at least two coils and a field focusing element and configured for providing bi-directional power transfer between a power source and a storage module on a vehicle;
a battery management system coupled to the storage module and configured to control a power flow to and from the storage module;
a processor coupled to the power source and configured to communicate with an external control station.

16. The intelligent charging system of claim 15, wherein the external control station comprises at least one of a utility based power distribution unit or a distributed power generation unit.

17. The intelligent charging system of claim 15 further comprising an inverter coupled to the power source.

18. The intelligent charging system of claim 17, wherein the battery management system is configured to transfer data to the processor via the contactless power transfer system.

19. The intelligent charging system of claim 15, wherein the processor is further configured to communicate power flow data and load data to the external control station.

20. The intelligent charging system of claim 15, wherein the field-focusing element comprises resonators configured to operate in at least two unique resonant frequencies.

21. A vehicle comprising:
a charging receptacle comprising an inlet comprising a dielectric region disposed within a cavity;
a secondary coil disposed within the cavity and coupled to a storage module; and
a field focusing element disposed proximate the dielectric region and configured to focus a magnetic field;
wherein the charging receptacle is configured for receiving a charging handle comprising a primary coil coupled to a power source.
